(19) United States
(12) Patent Application Publication
(10) Pub. No.: US 2015/0149935 A1
(43) Pub. Date: May 28, 2015

(54) INFORMATION BROWSER

(71) Applicant: RICHARD PAUL MCNEE, Red Deer (CA)

(72) Inventor: RICHARD PAUL MCNEE, Red Deer (CA)

(21) Appl. No.: 14/089,681

(22) Filed: Nov. 25, 2013

(51) Int. Cl. G06F 3/0484

(52) U.S. Cl. CPC G06F 3/0484
USPC 715/760

(57) ABSTRACT

An information browser is disclosed herein. The information browser is operable to display one or more of electronic files, file systems, data streams, videos, graphs, charts, web pages, and images. The appearance, behavior and functionality of every visual component of the browser and its displayed contents are duplicable, removable, and modifiable by the user.

### BACKGROUND OF THE INVENTION

1. Field of the Invention

The invention relates to an information browser, such as for obtaining data from the internet.

2. Description of Related Prior Art

U.S. Pat. No. 7,464,332 discloses DEVICES, SYSTEMS AND METHODS FOR SELECTING THE APPEARANCE OF A VIEWER DISPLAYING DIGITAL CONTENT. The '332 patent is directed to devices, systems and methods for selecting the appearance of a display on a viewer that displays the output of a digital content server, including tags, in html display, output custom or default information determined by the presence or absence of a unique identifier. In the event of perl-generated html, find and replace routines locate specific include tags and replace the include tags with custom or default information determined by the same unique identifier that dictates the selected viewer appearance. Accordingly, a vendor's web page may display content from a host's website while preserving the look and feel of the affiliate's web pages.

### SUMMARY OF THE INVENTION

In summary, the invention is an information browser. The information browser is operable to display one or more of electronic files, file systems, data streams, videos, graphs, charts, web pages, and images. The appearance, behavior and functionality of every visual component of the browser and its displayed contents are duplicable, removable, and modifiable by the user.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a simplified flow diagram followed by an information browser according to an exemplary embodiment of the invention;

FIG. 2 is a screen shot of a browser according to the prior art;

FIG. 3 is an exemplary screen shot visible to a user when modifying a visible object shown in FIG. 2;

FIG. 4 is an exemplary screen shot visible to a user when modifying toolbars and tool buttons shown in FIG. 3;

FIG. 5 is an exemplary screen shot visible to a user when executing an exemplary browser object removal;

FIG. 6A is an exemplary screen shot visible to a user of an exemplary browser window after several additional browser object modifications, additions, and removals;

FIG. 6B is an exemplary screen shot visible to a user of an exemplary browser window after several additional browser object modifications, additions, and removals relative to FIG. 6A;

FIG. 7 is a first exemplary screen shot visible to a user when additional exemplary browser object modifications are made without modification interface;

FIG. 8 is a second exemplary screen shot visible to a user when additional exemplary browser object modifications are made without modification interface;

FIG. 9 is a third exemplary screen shot visible to a user when additional browser object modifications are made;

FIG. 10 is a screen shot of an exemplary browser window showing a chat website with a pop-up chat object;

FIG. 11 is a screen shot of an exemplary browser object attached to another instance of the information browser;

FIG. 12 is a screen shot of browser objects being duplicated along a partial outline of the chat browser object;

FIG. 13 is a screen shot of browser objects attached to and circling around the outline of the chat browser object;

FIG. 14 is a screen shot of browser objects attached to and circling a user drawn path around another browser object;

FIG. 15 is a screen shot of a browser preview object and a shrunken browser window of a chat website attached to another instance of the information browser;

FIG. 16 is a screen shot of a browser object selection and relationship indication;

FIG. 17 schematically shows an example of vectorization of a raster image;

FIG. 18 is a pair of screen shots showing an example of one object cutting and dividing another object in a cookie cutter operation;

FIG. 19 is a pair of screen shots showing an example that any object can be anchored to a location on the display or current desktop such that it does not move with the browser window; and

FIG. 20 is a screen shot of an example of the creation of a three dimensional object from a browser object.

### DETAILED DESCRIPTION OF AN EXEMPLARY EMBODIMENT

The invention, as demonstrated by the exemplary embodiment described below, provides a web, media, and information browser wherein all visual and procedural properties of any object that is displayed can be modified by the user. Such visible objects can be duplicated, merged, or disassembled to form new customizable persistent browser objects. Web pages on the internet are often stand-alone displays of a company, an organization, or an individual's products or creative works. It has been observed by the inventor that consumers are looking to acquire graphically superior products that are mobile and entertaining. While existing products have provided basic functionality to the marketplace, their stand-alone and un-modifiable nature deprives consumers of what sufficient control over the display. The opportunity to provide consumers in almost all markets with the ability to customize products can be provided by embodiments of the invention.

Each visible and layout element of the browser, including its menu and controls, in addition to its displayed contents is a browser object. Said browser objects are operable to have their appearance, behavior, and functionality modified by the user in real-time while the browser displays live web pages and file folders. Browser objects are operable to persist outside an object's original source document, parent browser window, or file folder, even after the original source document is no longer visible within the browser. Browser objects are operable to maintain data connectivity enabling the display of updated data from the original data source, such as a web page, without re-displaying the entire original source. Each browser objects is operable to be both a parent object and a child object. Browser objects are detachable from their parent object and attachable to any other browser object, allowing visual and layout objects to be transferred between web pages, browser windows, and browser instances. As all visual elements of the browser itself are browser objects, the control menus, buttons, scrollbars, and window itself are modifiable by the user with respect to behavior, functionality, visual appearance, persistence, data connectivity, and transference.

The inventor has also observed that while a high level of customization is not obtainable in manufacturing, this limitation can be overcome in software applications. The exemplary embodiment is an information browser that produces a user customizable experience across web pages, media, and desktop environments. The exemplary information browser can allow users to pick, choose, and modify their web, media, and desktop experience to something they desire.

An information or web browser is a software application for retrieving and presenting information in a visual format to a user. An information browser can traverse information resources across the World Wide Web. The information that is retrieved can be presented to the user in the visual form of a web page, an image, a video clip, or text, generally. Text can be in the form of hyperlinks, which allow users easily to navigate the information browsers to sources of data.

Although browsers are primarily used in connection with the World Wide Web, they can also be used to access information provided by web servers in private networks or files in local file systems. Embodiments of the invention can be practiced in any operating environment of information browsers, including but not limited to desktop computers, tablets, and cellular phones.

As set forth above, a purpose of an information browser is to bring information/data to the user, allowing the user to view the information on a display. This retrieval process begins when the user inputs a request to the browser. The request can be in the form of a Uniform Resource Locator (URL), for example http://uspto.gov/. The prefix of the URL, the Uniform Resource Identifier or URI, determines how the URL will be interpreted. The most commonly used form of URI starts with “http:” and identifies a resource to be retrieved over Hypertext Transfer Protocol (HTTP). Many browsers also support a variety of other prefixes, such as “https:.” Embodiments of the invention can be operable to support other prefixes.

Once the resource has been retrieved, the information browser will display the data available from a server hosting the URL. Data is passed to the information browser's layout engine to be transformed from markup to an interactive document, a process known as “rendering”. Aside from HTML, web browsers can generally display any kind of content that can be part of a web page. Most browsers can display images, audio, video, and XML files, and often have plug-ins to support Flash applications and Java applets. Upon encountering a file of an unsupported type or a file that is set up to be downloaded rather than displayed, the browser prompts the user to save the file to disk.

In embodiments of the invention, an information browser can initiated object editing mode by one or more of keyboard input, button input, mouse clicks, and hovering the mouse pointer over a browser object. Once in editing mode, a collection of graphical editing tools, toolbars, and menus are available to the user to modify the visual and behavior aspects of the selected browser object or objects. While in editing mode, script execution for the selected object is disabled.

The retrieved data may include hyperlinks to other information resources. Each hyperlink contains a URI of a resource. When a hyperlink is clicked, the information browser navigates to the resource indicated by the link's target URI, and the process of bringing content to the user begins again. Embodiments of the invention can be operable to display and act on hyperlinks.

An exemplary embodiment of the broader invention can be a web/media/desktop information browser that allows users full control over the visual aspects of all objects viewed in the information browser as well as the information browser itself. This allows text to be re-sized, morphed, colorized, etc., for example. In another non-limiting example, a user can create a circus effect around a chat window, or pull images of flowers off of a web site and decorate their desktop with scaled or modified copies of the image. The user can also modify the behavior of any object, so, with the flowers example, the user could animate the flowers to circle around the main information browser window or around another object viewed in the information browser. Browser objects, or objects retrieved by the information browser, can remain independent and persist so tiling widgets or applications can be organized in any fashion the user desires.

Since the information browser itself can be modified just as the objects viewed within it, the information browser allows for a much more creative experience than the simple themes currently available on browsers. The user can reshape a browser window, such as by erasing sections, warping sections, adding images, etc. An embodiment of the information browser might also allows users to block or discard any objects they do not wish to view, thereby giving the user power to block ads and other material that is not of interest.

It is noted that embodiments can be created in any programming language desired.

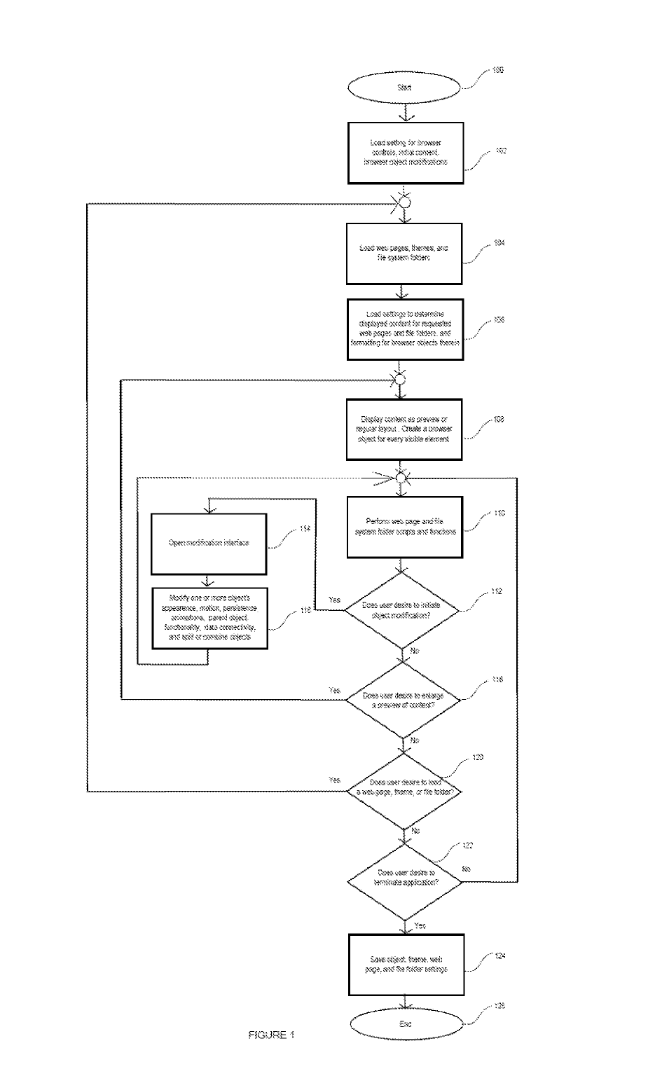

FIG. 1 shows the steps that can be followed by an information browser according to an exemplary embodiment of the invention. The process starts at 100. At step 102, the information browser can load one or more files, the content of which determine browser settings, initial content displayed, initial browser object modification, and browser object behavior. In some embodiments, previously downloaded theme files may be loaded to create browser objects and modifications. Different themes may result in various selections of transparency, dimensions, shape, outline, z-order, position, rotation, morphing, motion, color, fonts, and animation of various preloaded objects. One theme example might be a space motif, wherein the information browser control buttons circle around an image of a planet, and the main window background is a rotating image of a galaxy.

At step 104, the information browser can download the digital content and open local content specified in step 102. Additionally, content is retrieved for subsequent requests by the user for web pages, themes, or file folders.

At step 106, the information browser is operable to load settings that determine what content the user desires to display for a given web page or file folder specified in step 104. Additionally, the loaded settings can be used to perform browser object modification on the content specified, or to disable various modifications.

At step 108, the information browser creates a visual layout for the content specified in step 106. For every element of the visual layout a browser object is created. Objects may include structural organizational objects such as tables, table cells, spans, etc. Browser objects can be hierarchical, in that some objects can be children of parent objects. Child objects are modifiable such that they can be detached from their parent and become a child of another object, or remain as a top level object; making them an independent browser. If specified in the browser settings, or specific web site or file folder specific settings, the web page or file folder can initially be displayed as a miniature preview object. The preview object is a smaller version of a browser window without navigation controls. The preview of a web page or file folder can have its scripts and commands deactivated. The information browser can also be operable to display a size of the data required to download a web page, media file, or media stream is displayed with the preview. This will allow the user to exercise at least some control over the visual display that will be generated. The information browser can be operable to allow the user to alter the visual attributes of the preview as well.

At step 110, the information browser is operable to display the web pages and file folders requested by the user. In addition the browser performs any scripts that might be run within a browser object or file folder. Such scripts may alter the appearance, motion, and animation of browser objects as well as prompt the user for input. Additionally, web page functions are performed such as retrieving additional data from a server.

At step 112, the information browser can process user input to monitor whether the user desires to implicate or change the appearance, behavior and functionality of any browser object of the information browser or the displayed contents.

At step 114, the information browser initiates the modification interface. In modification mode the interface is operable to display a collection of editing tools, toolbars, and menus to the user to modify the visual and behavior aspects of the selected browser object or objects. While the information browser is operating in modification mode, script execution for browser objects is disabled.

At step 116, the information browser is in modification mode and is operable to receive commands from the user to duplicate, split, merge, remove, or modify any of the displayed objects and can execute such commands. In executing one exemplary command, the information browser can wrap, scale, bend, discolor, blend, merge, twist, warp, disassemble, or animate one or more visible objects. In executing another exemplary command, the information browser can copy a visual object and attach the object to another displayed web page, folder view, desktop view, or other displayed object within the same instance or another instance of the information browser. In executing another exemplary command, the information browser can extract and transfer component commands, scripts, and parameters between components.

The information browser is operable to change the visual attributes of browser objects over time by means of a sequence of morphs, created and timed by the user.

The information browser is operable to enable the user to select multiple browser objects, including the entity of information browser window, its controls, menus, and its contents. Once selected, the information browser is operable to be modified the visual attributes of all selected objects together with a single modification action.

The information browser is operable to enable any browser object to be anchored to a location on the display. Anchored browser objects do not change position when the parent browser window moves.

The information browser is operable to enable the user to select multiple appearance attributes to be modified by the currently selected operation, without modifying other appearance attributes. For example, color and font size values may be reduced without modifying transparency values. One or more attributes may be disabled at user request, such as animations, hue, motion, persistence, data connectivity, etc.

The information browser is operable to provide off-screen memory buffers on which plug-ins display their content. The buffers are utilized by the plug-in browser object to create on-screen images which are fully modifiable by the user.

The information browser is operable to create browser objects, at user command, such that said browser objects flood-fill a selected area in a tiled manner. Each repeated instance in the tiled area is a browser object.

The information browser is operable to create browser objects, at user command, such that said browser objects flood-fill a selected area in a tiled manner. Each repeated instance in the tiled area is a browser object. Areas selected for tiling, among other operations, may be selected by means of color similarity of raster graphics displayed on browser objects. By clicking mouse buttons, keyboard keys, or hovering the mouse over a color on a browser object, the information browser is operable to highlight the contiguous colors within a range specified by the user.

The information browser is operable to enable browser object morphs and modifications to be triggered by user actions, by script commands, or by communication event. For example, a user might trigger an image browser object to circle a path around a chat window, and play a sound, whenever a new message arrives.

The information browser is operable to change the persistence of objects, allowing the objects to remain active after their current parent object or information browser window is closed. The persistent objects are able to maintain their relationship with the parent object or information browser window upon redisplaying said parent or browser window. The information browser is operable to change the hierarchical relationships between objects, adding objects to a parent object or removing child objects from a parent object. A parent object can simultaneously be a child object.

The information browser is operable to create or remove browser object data connectivity with the original data source. For example, if, by removing the corresponding browser objects, the user removes all of a web page's content, except for a table cell that holds a portion of an online news feed, the table cell browser object can be data connected to the original web page's table cell, such that upon periodically refreshing the source information, the updated news appears in the table cell browser object, without displaying additional web page content.

The information browser is operable to create paths, remove paths, attach objects to paths, and remove objects from paths. Paths may be user drawn lines or curves modifiable by altering control points along the path. Paths may also be created from the outlines of objects, or from vector lines and parameters created from converting raster graphics, such as images, into vector form. Paths are themselves browser objects, and as such are fully modifiable. Any object attached to a path becomes a child object of that path. Paths may be static or dynamic. Dynamic paths are able to change position and shape over time, as any other object can. Paths can dynamically change the visual appearance of the objects attached to them.

The information browser is operable to create three dimensional browser objects from two dimensional browser objects, by command of the user in the modification interface. Three dimensional modifications include extruding all or part of a browser object into the third dimension, and rotating all or part of a browser object up to 360 degrees about an axis. Said axis is not required to be in the plane of the two dimensional browser objects.

In modification mode, the interface toolbars, menus, and editing tools can also have their appearance modified by the user. All browser objects can have one or more of their properties and relationships reset as to undo one or more user modifications.

At step 118, the information browser is operable to monitor whether the user desires to enlarge a preview of a web page or file folder. Preview objects are smaller version of a browser window without navigation controls. A preview is modifiable as with other browser objects.

At step 120, the information browser is operable to monitor whether the user desires to open another web page or file folder.

At step 122, the information browser is operable to monitor whether the user desires to terminate the current top level browser object. Top level browser objects are initially customary information browsers with navigation bars, and controls. Upon modifying a browser object to have no parent object, they browser object becomes a persistent top level browser object. Persistent top level browser objects are independent of other browser windows and are their own browser window. Terminating the former parent browser window of a persistent object will not terminate that object.

At step 124, the information browser window, that is requested terminated by the user, saves object, theme, web page, and file folder settings. The browser is operable to save settings to permanent storage device. For example, settings may include object positions, data sources, modifications, history, behavior, persistence, visible controls, and tool modifications.

At step 126, the exemplary process ends.

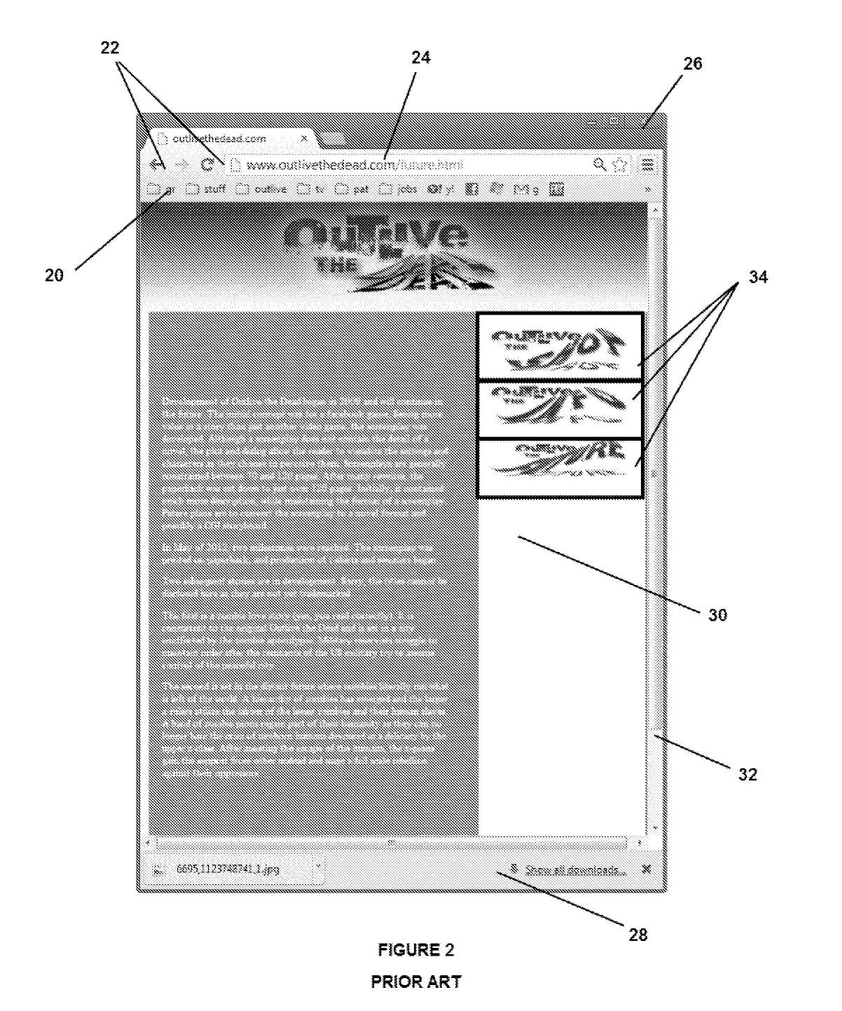

FIGS. 2-18 illustrate aspects of other embodiments of the broader invention. FIG. 2 is a screen shot of a browser according to the prior art. The browser displays several different visible objects, including links and folders referenced at 20, Window navigation controls referenced at 22, a document URL referenced at 24, Window control buttons referenced at 26, and a status bar and download bar referenced at 28. Information browser content is displayed in main window referenced at 30. The display of information can be varied with a main content window scroll bar referenced at 32. Example table cells are shown in FIG. 2, bordered in black to indicate boundaries for illustration purposes. These table cells are referenced at 34.

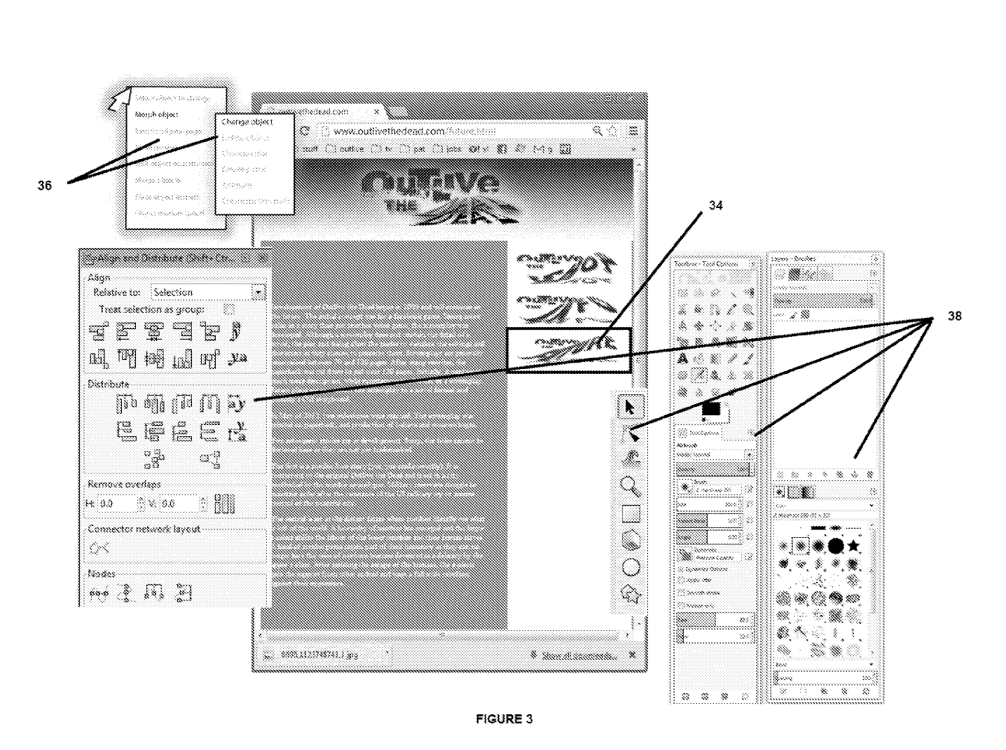

FIG. 3 is an exemplary screen shot visible to use when modifying a visible object shown in FIG. 2. The user has selected one of the table cells 34 shown in FIG. 2 to modify. As shown in FIG. 3, the user can be presented with exemplary user-customizable menus, referenced at 36. The user has also been presented with user-customizable toolbars and tools, referenced at 38. The choices made from the menus and the tools used change the appearance of the table cell 34.

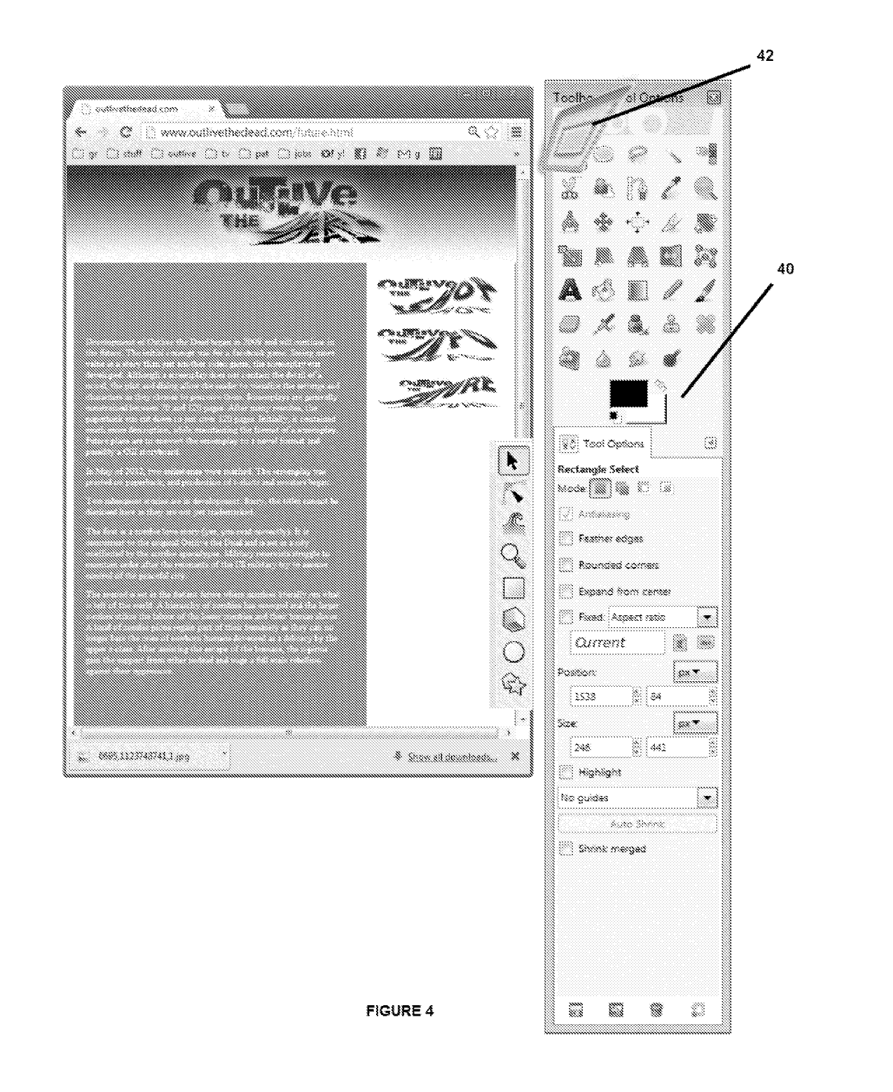

FIG. 4 is an exemplary screen shot visible to a user when modifying toolbars and tool buttons shown in FIG. 3. In this example, the user has chosen to resize one of the toolbars, as referenced at 40. The user has enlarged the modification interface toolbar. The entire contents have been resized, instead of only enlarging the toolbar window itself. The user has also modified the interface control. In this example, the user has sheared, rotated, and enlarged one of the buttons, as referenced at 42. The user has also hidden several interface tools bars in FIG. 4 relative to FIG. 3.

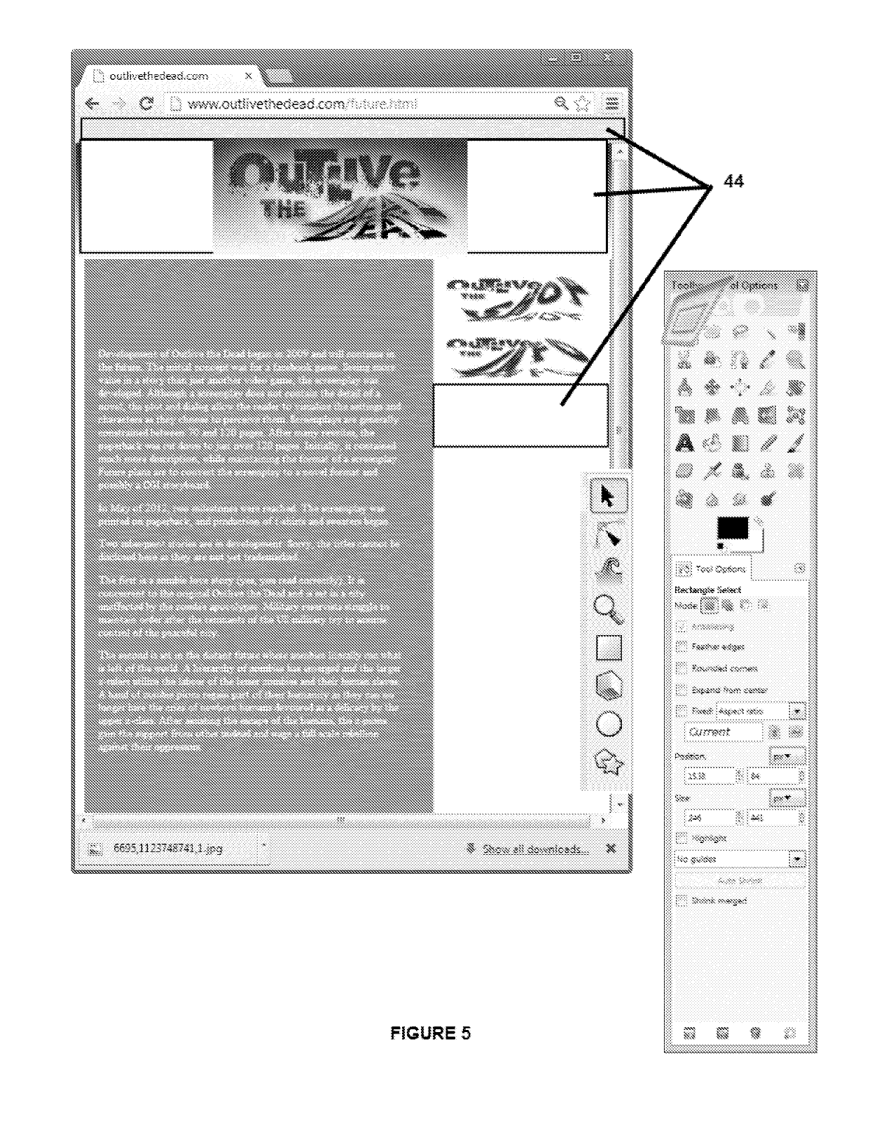

FIG. 5 is an illustration of exemplary browser object removal. As shown in FIG. 5 by comparison to FIG. 4, browser objects have been removed by the user. These browser objects include links, toolbars, cascading style sheet backgrounds, and image objects. The areas of the display in which these items appeared are referenced generally at 44.

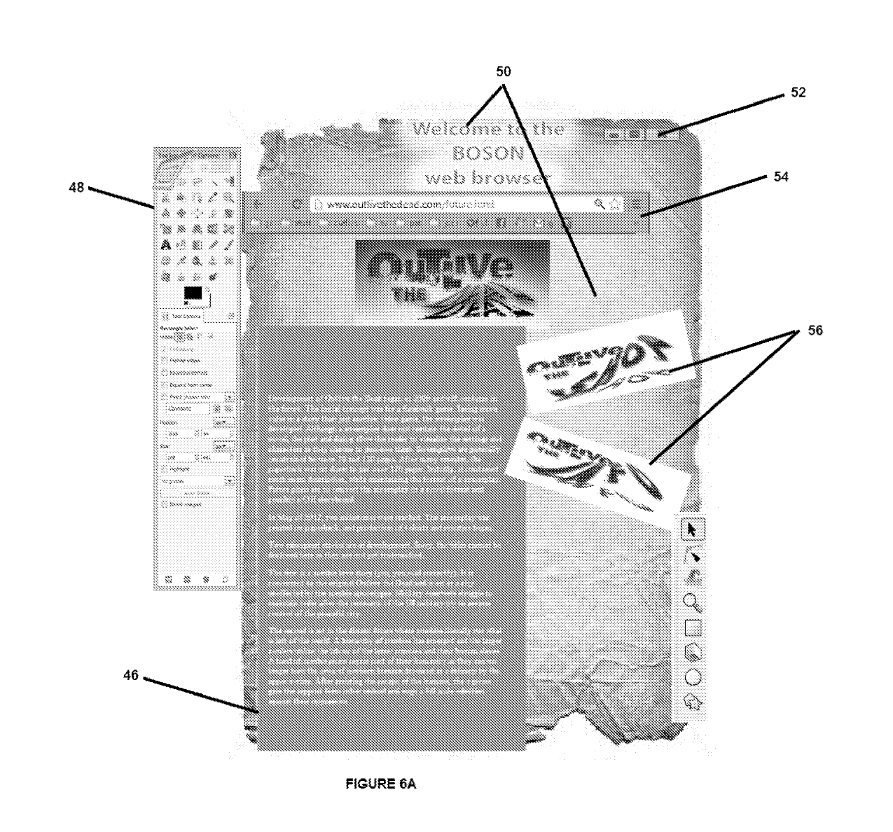

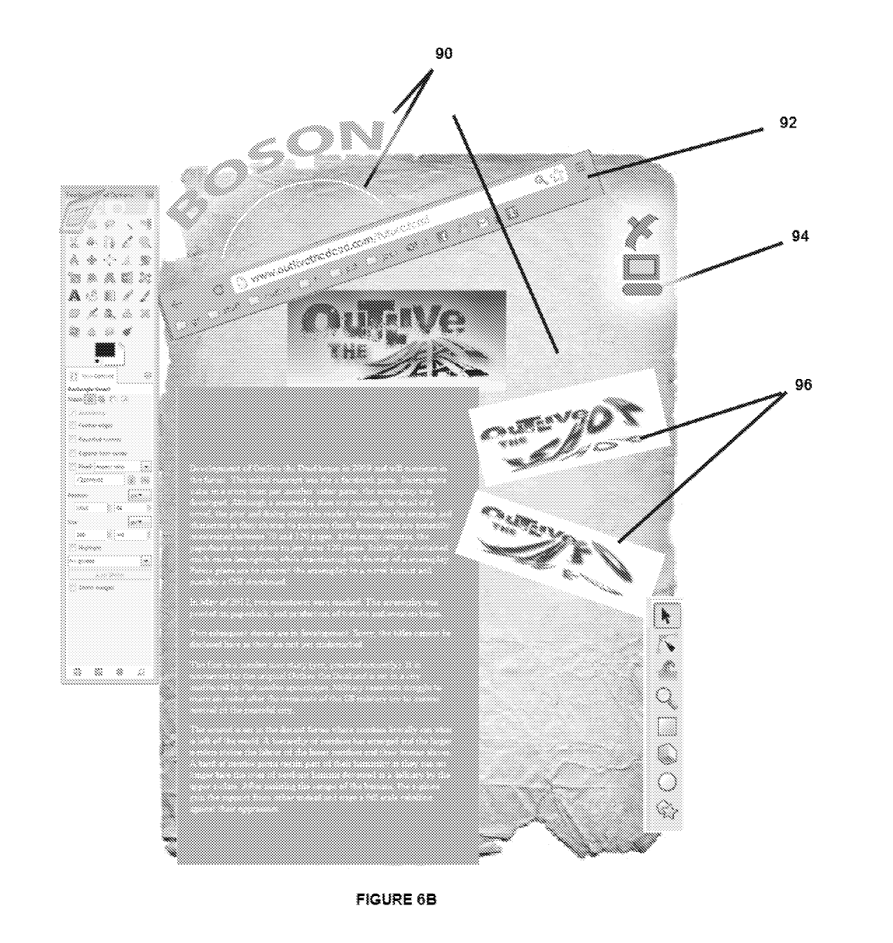

FIG. 6 is an illustration of an exemplary browser window after several additional browser object modifications, additions, and removals. An example of a browser object removal is referenced at 46. Here, the user has removed the scroll, status and download bars. Interface tools, menus, etc. are moveable within or external to the bounds of the information browser, much like all other browser objects. The user has done this, as referenced at 48.

FIG. 6A also shows an example of a browser object addition. The user can attach text, paths, images, etc. to information browser instances. As referenced at 50, the user has added a title text object in place of the title bar and tab bar, and changed the background object.

FIG. 6A also shows an example of browser control object modification by the user. Browser controls objects can be graphically modified through an information browser supplied graphic editor or by external programs. This is shown at 52.

FIG. 6A also shows an example of browser object re-addition by the user. As referenced at 54, the links toolbar has been re-added.

FIG. 6A also shows an example of browser content object modification by the user. Browser content objects can be graphically modified through toolbars, an information browser supplied graphic editor, or by external programs. Browser content object modifications by the user are referenced at 56.

FIG. 6B is an exemplary screen shot visible to a user of an exemplary browser window after several additional browser object modifications, additions, and removals relative to FIG. 6A. At 90, additional user modifications after using rotation, text, and scale tools are shown. At 92, an additional user modification after using a rotation tool is shown. At 94, an example of browser control object modification by the user is shown. Here, the slightly modified buttons were replaced with much more artistic versions. At 96, another example of browser content object modification by the user is shown. Browser content objects can be graphically modified through toolbars, an information browser supplied graphic editor or by external programs.

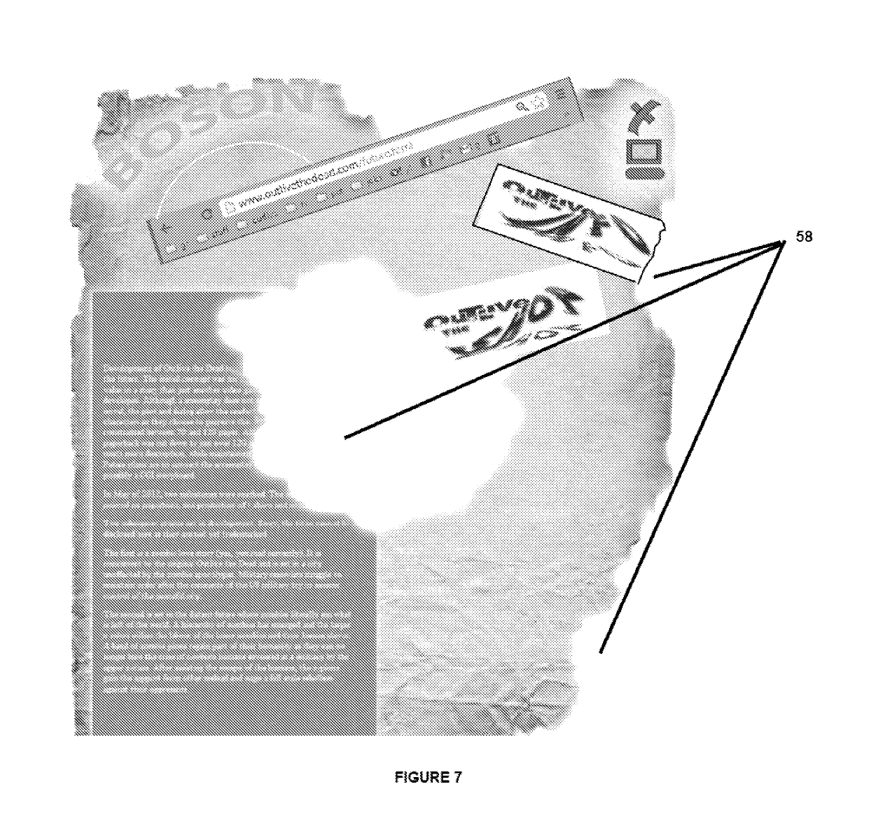

FIG. 7 is an exemplary screen shot visible to a user when additional exemplary browser object modifications are shown without modification interface. As referenced at 58, the background browser object is modifiable by the user to delete some content. Multiple layers of content can be modified in a single action.

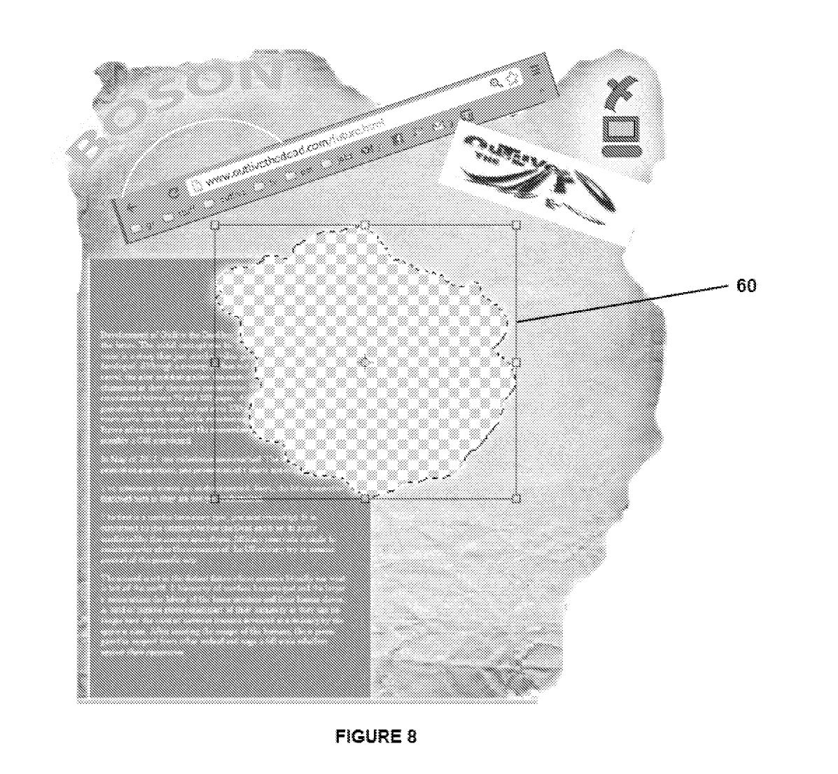

FIG. 8 is another exemplary screen shot visible to a user when additional exemplary browser object modifications are shown without modification interface. As referenced at 60, graphic edits such as erase are themselves browser objects that can be modified—shaped, made persistent, etc. The edits have a path outline that is modifiable by the user.

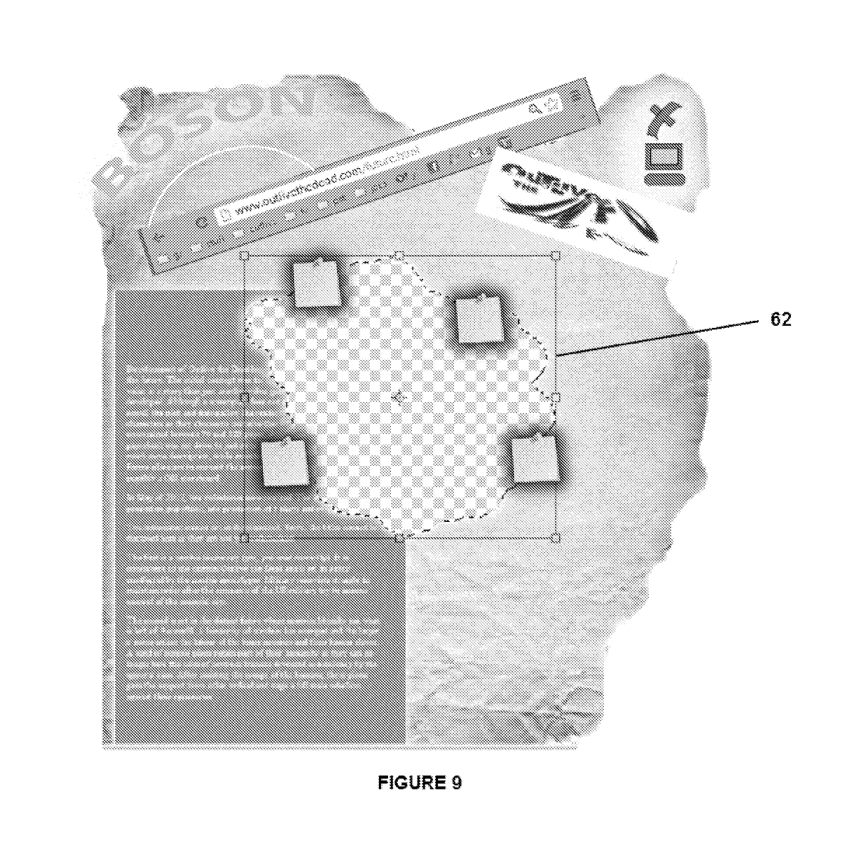

FIG. 9 is a third exemplary screen shot visible to a user when additional browser object modifications are made. The modifications, referenced at 62, are themselves browser objects. Browser objects are duplicated around the path surrounding a graphic edit object.

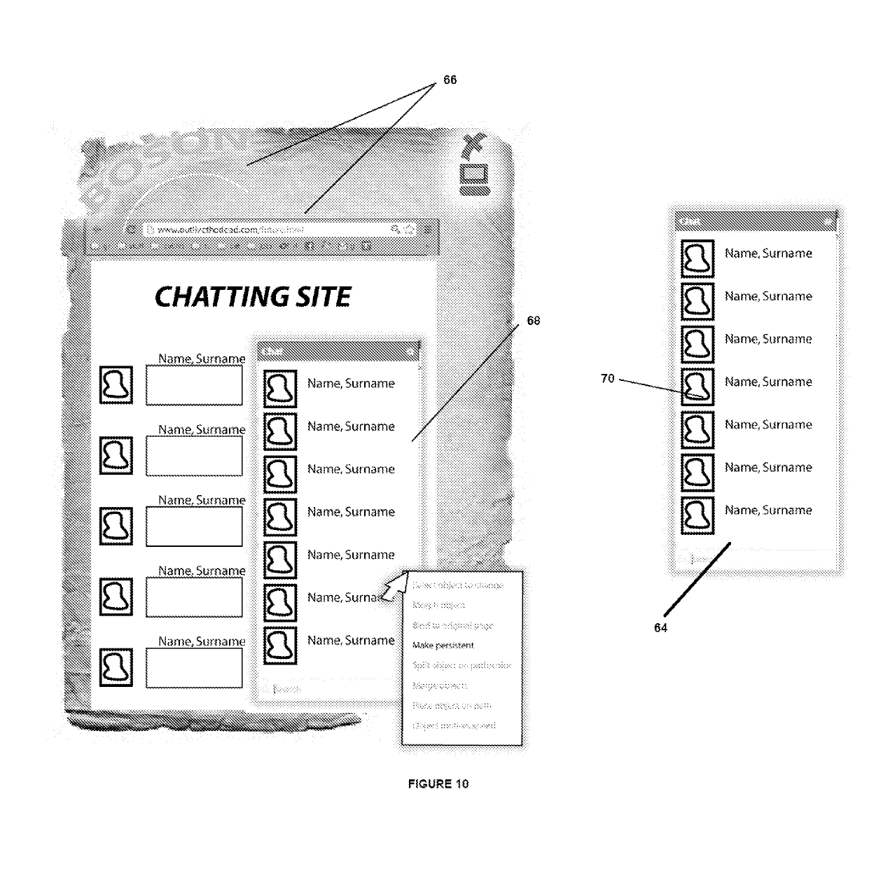

FIG. 10 is a screen shot of an exemplary browser window showing a chat website with a pop-up chat object. An exemplary browser chat object showing data connectivity and persistence is referenced at 64. At 66, browser instances can share as many common elements as the user desires. Modifications can be applied to all new instances of browsers or to select instances. At 68, browser objects can be made persistent and data connected to their original data source such as a web site or file folder. Objects can also be transferred to other browser instances. At 70, the chat browser object is made into a persistent top-level object. As such it is not attached to an information browser window and it will not terminate when its original browser window is closed. The object has been modified to maintain its data connection to its original chat website. As such, it still functions as though it were on its original web page.

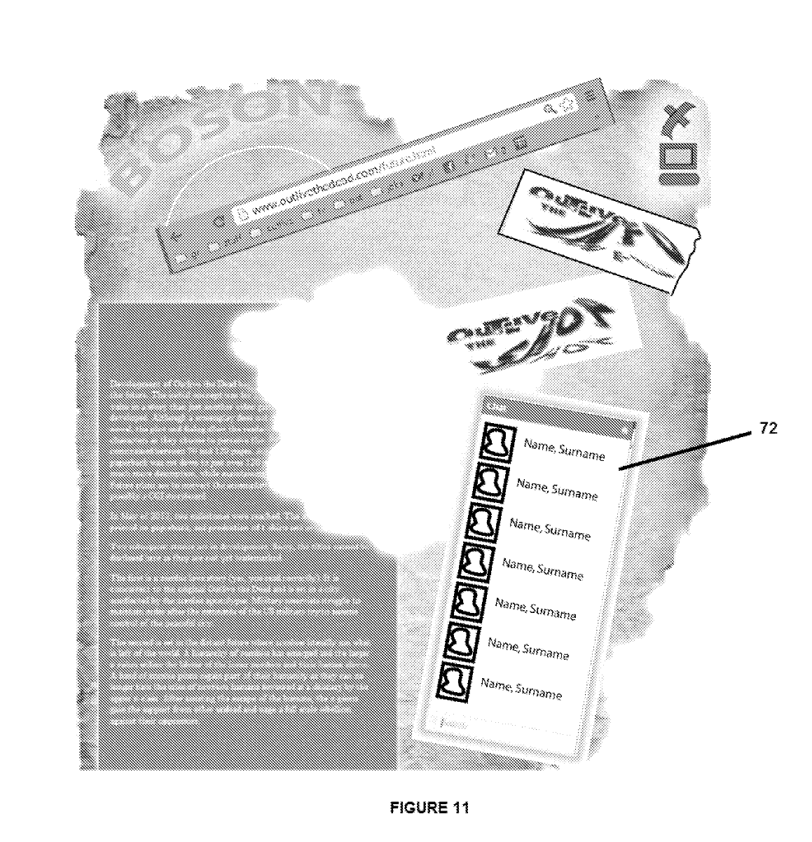

FIG. 11 is a screen shot of an exemplary browser object, referenced in 72, attached to another instance of the information browser. The chat object has been set up to maintain data connectivity with its original chat website, but is no longer a persistent top level object, as it is now a child object of this browser instance. At 72, the chat browser object is attached to another browser instance. It has also been modified with respect to rotation and scale.

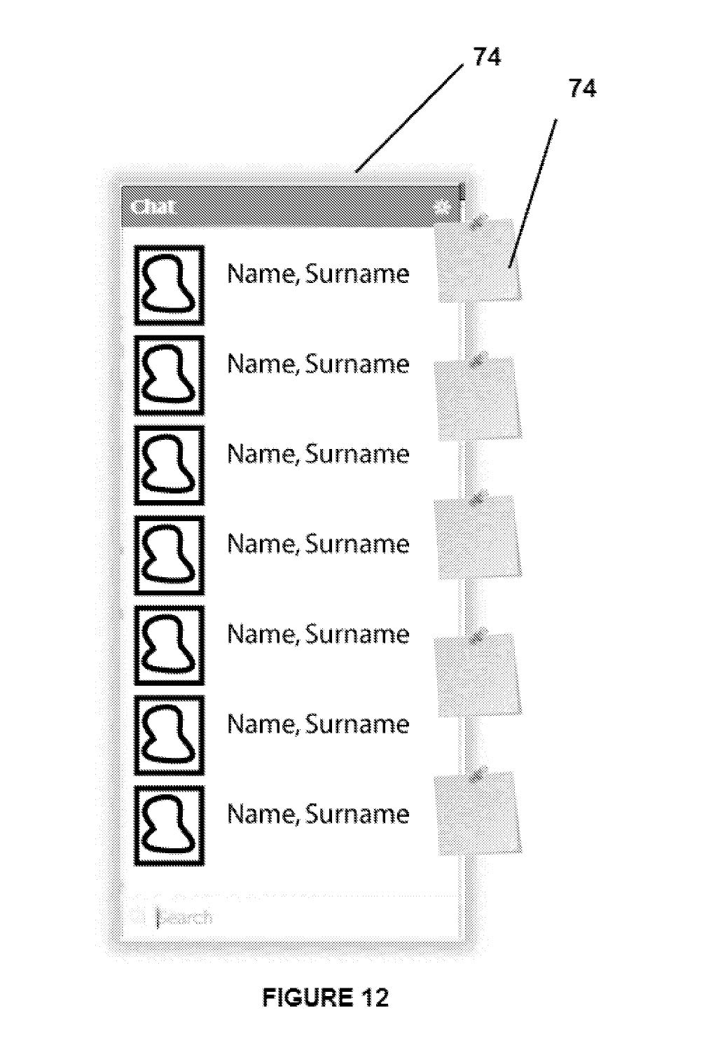

FIG. 12 is a screen shot of browser objects being duplicated along a partial outline of the chat browser object. At 74, browser objects outlines are paths onto which other browser objects can be attached.

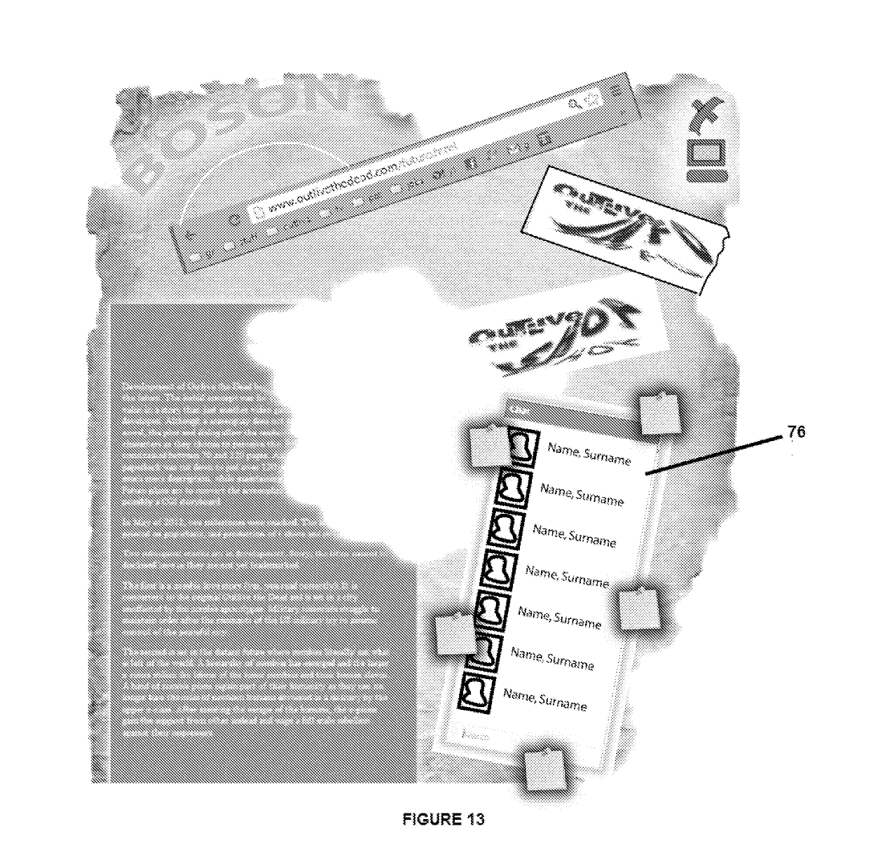

FIG. 13 is a screen shot of browser objects attached to and circling around the outline of the chat browser object. The result shown in FIG. 13 can be triggered when a new chat message is received through the chat object's data connection to its chat website. At 76, a newly received chat message triggers a user created animation, causing objects attached to the path around the chat object to be highlighted and circle the path.

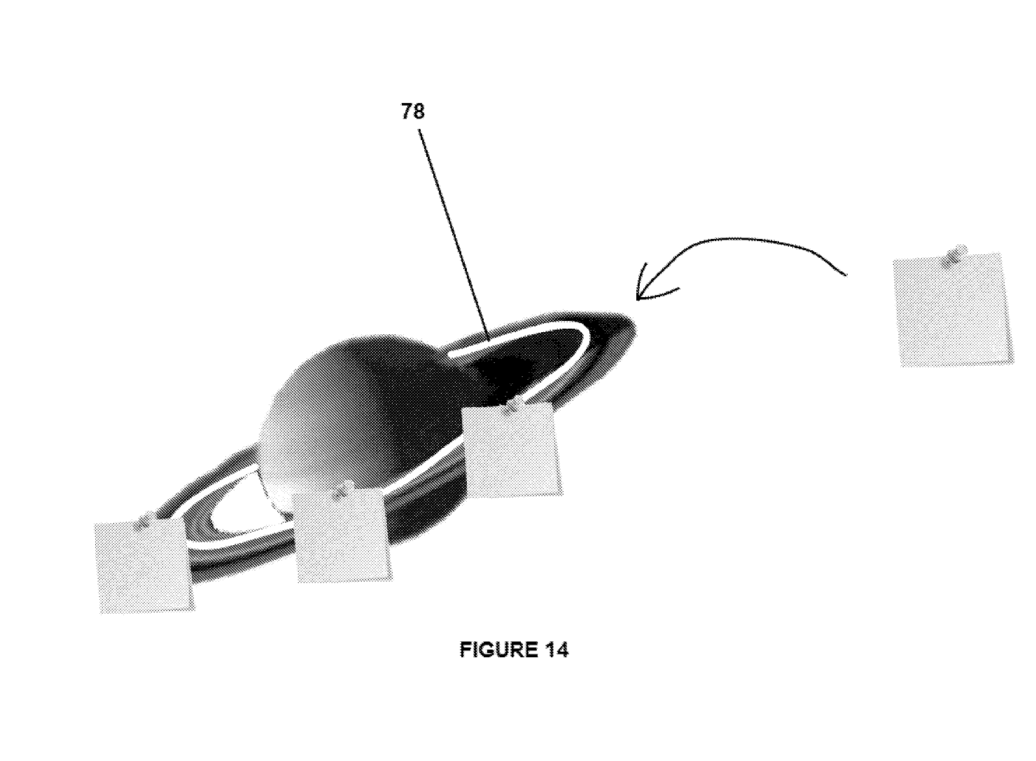

FIG. 14 is a screen shot of browser objects attached to and circling a user drawn path around another browser object. Links, icons, browser objects, displayed objects, and previews are attachable to static or dynamic paths that dynamically change one or more of the location, shape, size, color, transparency, and z-order of the objects attached to the paths. By user command, an object attached to a path may be duplicated at regular intervals along said path or duplicated to fill another object's displayed area. At 78, a user created path determined by a browser based on similar color pixels is shown.

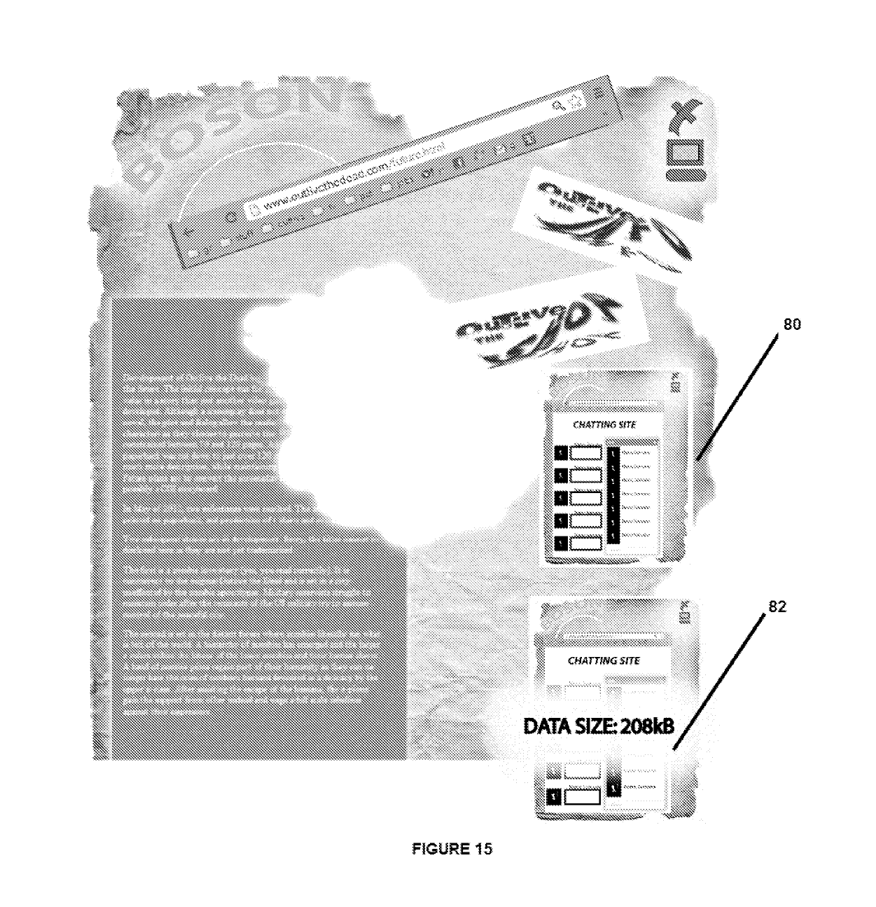

FIG. 15 is a screen shot of a browser preview object and a shrunken browser window of a chat website attached to another instance of the information browser. At 80, an entire browser window and its contents can be resized, including the user controls, buttons, and menus. Here the shrunken browser is made a child of another instance of the browser. The content of the shrunken browser is still active and may be updated live from the original web page. At 82, a preview of a chat website is displayed to the user. Scripts for a preview page can be disabled by the user or by default through browser settings. The size of initially displaying the previewed web page or file folder can be displayed to the user. The displayed data size text is also a modifiable browser object.

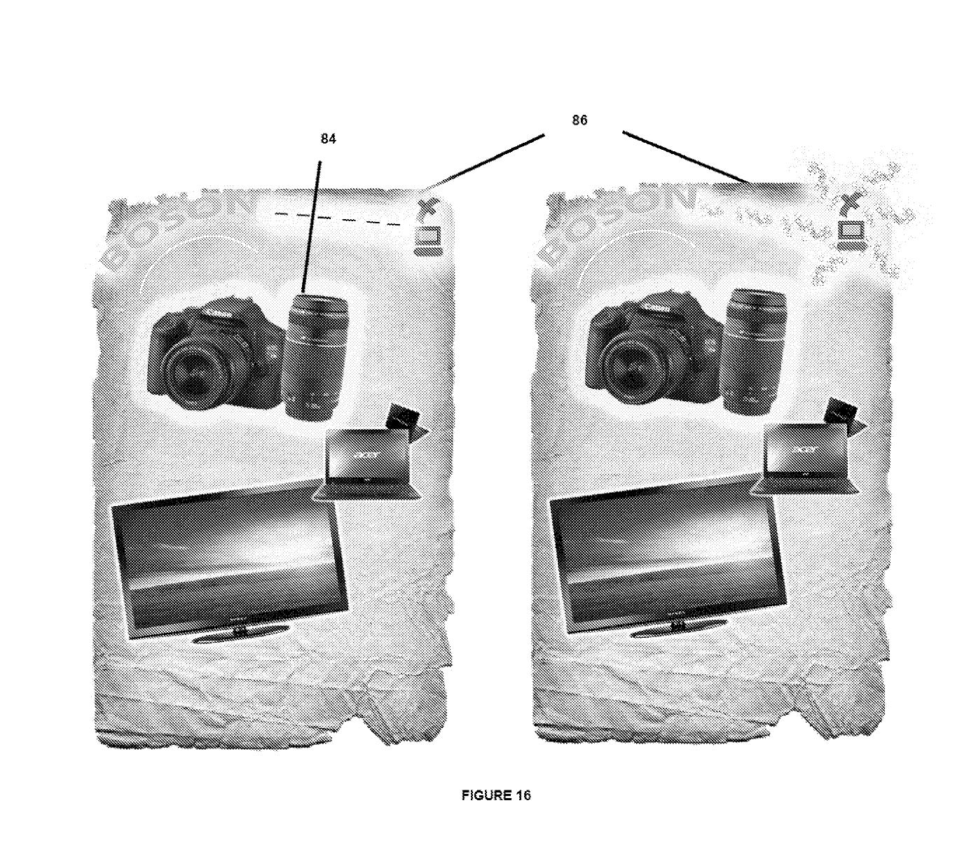

FIG. 16 is a screen shot of a browser object selection and relationship indication. At 84, a selection mode is available such that browser objects are highlighted as the user moves a mouse, indicator, or finger—in the case of tactile displays, over the object. A highlighting method can be chosen by the user, such as outer glow, enlargement of the object pointed to, etc. At 86, since objects can be destroyed by the user, all remaining objects of a parent browser window or parent object can be indicated by dotted, dashed, or user defined images, or via a user defined action such as the objects glowing, flashing, animation, or motion.

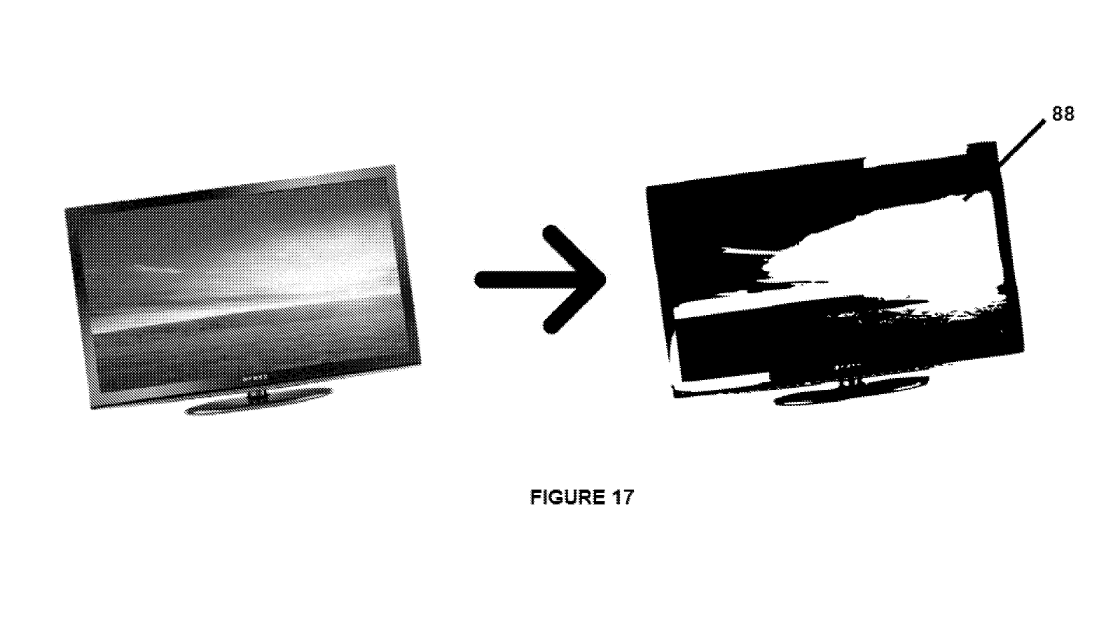

FIG. 17 schematically shows an example of vectorization of a raster image. At 88, paths can be created on the edges of vector lines in the vectorized version of the raster image. Edges are denoted by the color that fills the interior of the edges, within specified ranges set by the user.

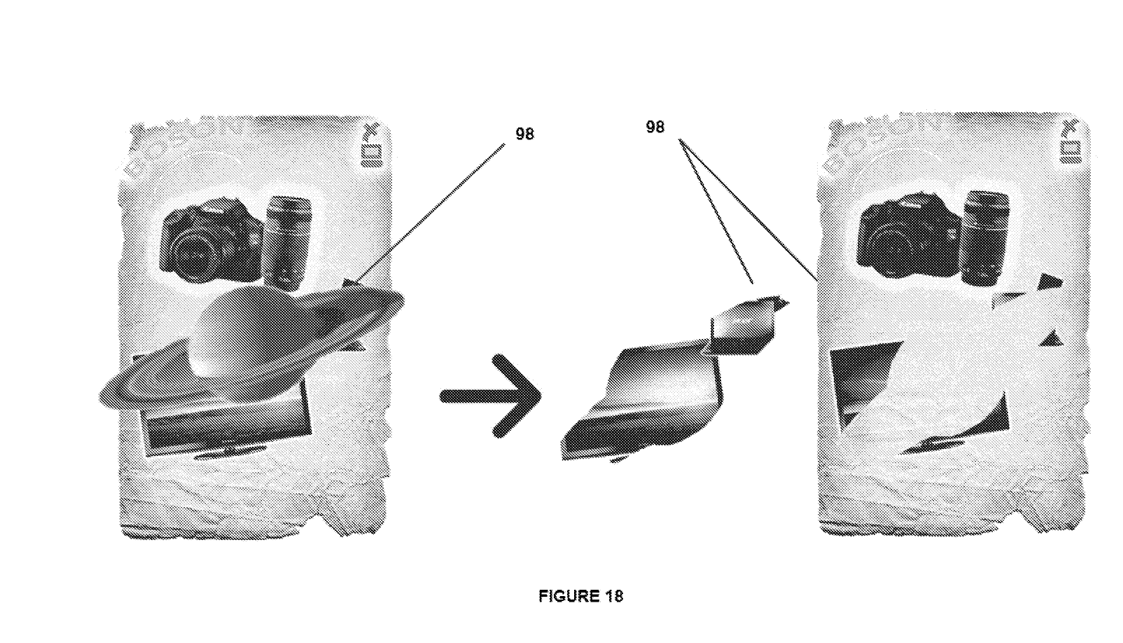

FIG. 18 is a pair of screen shots showing, at 98, an example of one object cutting and dividing another object in a cookie cutter operation.

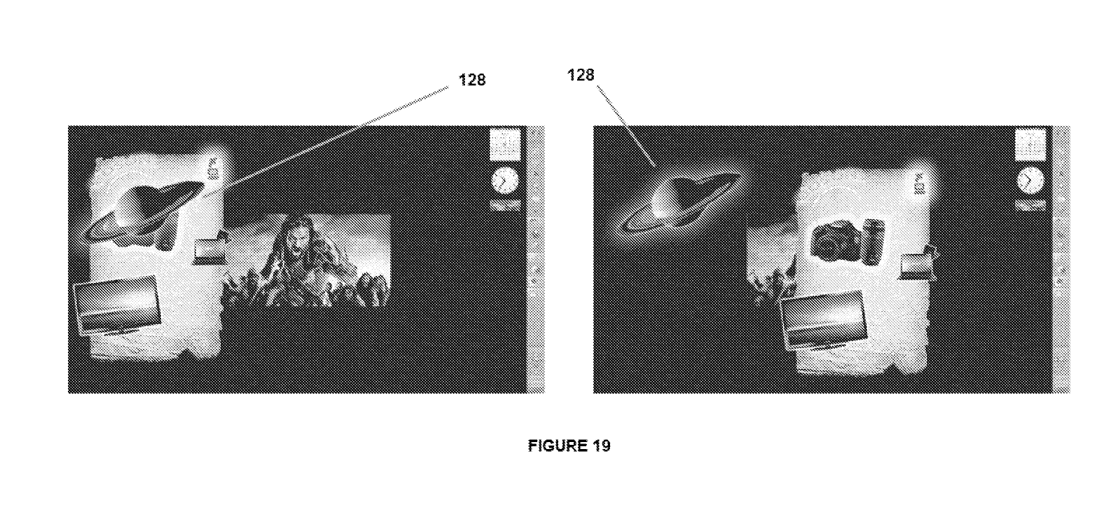

FIG. 19 is a pair of screen shots showing, at 128, an example that any object can be anchored to a location on the display or current desktop such that it does not move with the browser window.

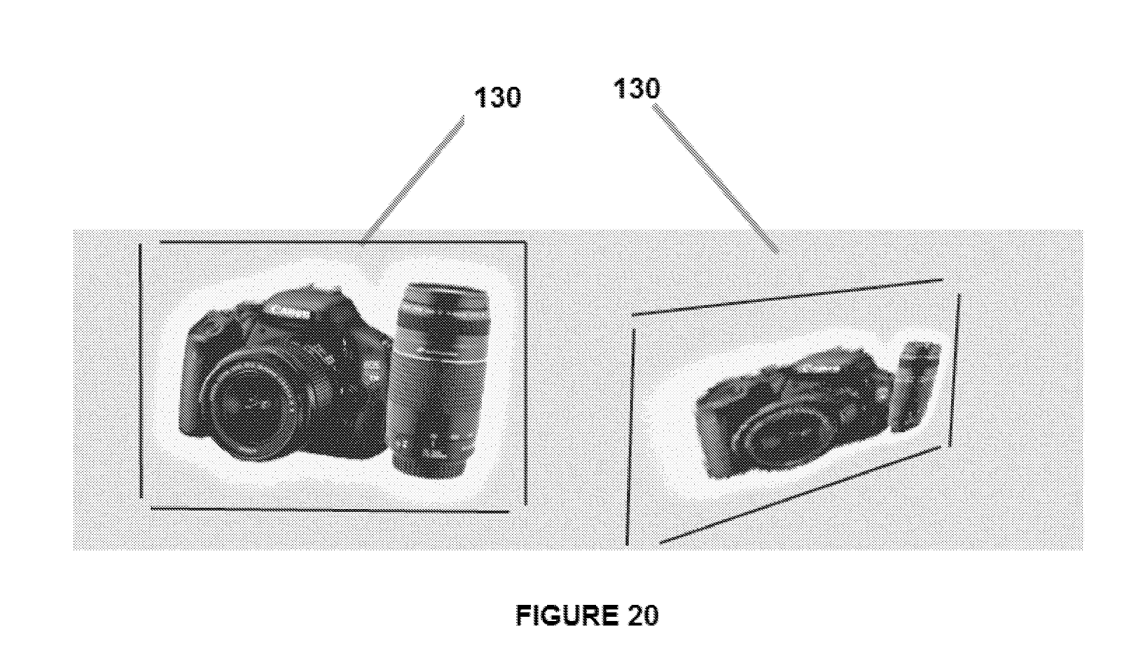

FIG. 20 is a screen shot of an example of the creation of a three dimensional object from a browser object, referenced at 130. Any browser object, including controls, window borders, and displayed contents are operable to be modified in this manner.

It is noted that embodiments of the broader invention, demonstrated herein by one embodiment, can allow the sharing, duplication, modification, and customization of all visual and behavioral properties of the individual elements of one or more web pages, and files. Much more than meta data, the transfer and modification of all visual aspects (including, but not limited to, motion, transparency, color, morphing, and transformation) and functionality is possible, allowing the user to copy web page elements, or their properties, and attach them to another object or duplicate the original object to persist after the original web page object source is no longer being viewed by the user. The capacity of objects to contain procedures and visual aspects of multiple other objects allows for a creative environment where several web objects can be combined or divided to form a larger pool of components. The ability to acquire a font or an animation from one element and copy it to another element allows the user to pick and choose what portions of the Internet they desire, and can use those portions to create a unique web experience. Each element of a web page is an object in and of itself. Thus, each object accessed by the information browser can persist after an individual web page has been closed, allowing for the creation of desktop widgets from common web page components.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. An information browser operable to display one or more of electronic files, file systems, data streams, videos, web pages, and images, wherein the appearance, behavior and functionality of every visual component of the browser, its controls, its toolbars, its border, and its displayed contents is operable to be duplicated, removed, and modified by the user.

2. An information browser wherein every visible component of the browser window, its control, its toolbars, its border, and its displayed content is a browser object such that every browser object is operable to have equivalent functionality.

3. The information browser of claim 1, wherein said information browser is operable receive one or more theme files loaded into said information browser, the one or more theme files being operable to control visible attributes of the information browser, its controls, and its displayed contents, including transparency, dimensions, shape, outline, z-order, position, rotation, morphing, motion, color, fonts, and animation.

4. The information browser of claim 2, wherein said information browser is operable to display browser objects and any displayed object may persist independently after its parent document, web page, or file folder has been closed or changed to an inactive or unfocussed state, and remain as part of said information browser at the command of the user.

5. The information browser of claim 1, wherein said information browser is operable to display visible objects and said visible objects can be wrapped, scaled, bent, discolored, blended, merged, twisted, warped, disassembled, or animated.

6. The information browser of claim 2, wherein said information browser is operable to display visible objects and said displayed objects can be copied or attached to another displayed web page, folder view, desktop view, or other displayed object within the same instance or another instance of the browser.

7. The information browser of claim 2, wherein said information browser is operable to display visible components and wherein said information browser is operable to extract and transfer component commands, scripts, and parameters between components.

8. The information browser of claim 1, wherein said information browser is operable to display visible links, icons, browser objects, displayed objects, and previews and wherein said links, icons, browser objects, displayed objects, and previews are attachable to static or dynamic paths that dynamically change one or more of the location, shape, size, color, transparency, and z-order of the objects attached to the paths.

9. The information browser of claim 8, wherein said paths are user drawn, created around browser object outlines, created on vector and parametric lines used to display a browser object, or created on vectorized versions of raster images.

10. The information browser of claim 1, wherein said information browser is operable to display a smaller sized preview of a web page or file folder as a modifiable browser window without navigation controls.

11. The information browser of claim 10, wherein said preview of a web page or media stream is operable to have its scripts and commands deactivated.

12. The information browser of claim 10, wherein said information browser is operable to display a size of the data required to download a web page, media file, or media stream is displayed with the preview.

13. The information browser of claim 1, wherein the information browser is operable to enable any number of selected browser objects, up to and including the entire information browser window, its controls, menus, and its contents, to be modified together by a single modification action.

14. The information browser of claim 1, wherein the information browser is operable to have one or more browser objects divide other underlying browser objects into multiple browser objects, in the same manner as a cookie-cutter works.

15. An information browser operable to enable any browser object to be anchored to a location on the display, such that the browser object does not change position when the browser window moves.

16. The information browser of claim 1, wherein the information browser is operable to provide off-screen memory buffers on which plug-ins display their content, such that the buffers are converted into on-screen browser objects which are fully modifiable by the user.

17. The information browser of claim 1, wherein the information browser is operable to enable the user to select one or more appearance attributes to be modified by the currently selected graphic modification tool, without modifying other appearance attributes.

18. The information browser of claim 1, wherein the information browser is operable to enable the user to enable or disable one or more visual, behavioral, or functional attributes of objects.

19. The information browser of claim 1, wherein the information browser is operable to reset the attributes of any browser object to its original pre-modification state.

20. The information browser of claim 1, wherein the information browser is operable to enable visual morphs for a browser object to changed over time via a list of morphing instructions.

21. The information browser of claim 1, wherein the information browser is operable to enable browser objects attached to a path to be duplicated at regular intervals along said path, the spacing of which is determined by the user.

22. The information browser of claim 1, wherein the information browser is operable to enable browser objects to be duplicated in a tiled manner to fill a selected area of another object, at the request of the user.

23. The information browser of claim 1, wherein the information browser is operable to enable browser object morphs and modifications to be triggered by user actions, by script commands, or by communication event.

24. The information browser of claim 1, wherein the information browser is operable to enable the user to edit points that control and define paths.

25. The information browser of claim 1, wherein the information browser is operable to create browser objects for graphic modifications done to other browser objects, such that the graphic modification objects are also modifiable by the user.

26. The information browser of claim 1, wherein the information browser is operable to create a three dimensional browser object from browser object, such that the three dimensional browser object is either, in whole or in part, extrude into the third dimension, rotated about an axis on the two dimensional browser object, or rotated about an axis at a distance in front of or behind the two dimensional browser object so as to create a donut shaped object.

27. The information browser of claim 26, wherein the information browser is operable to rotate a two dimensional browser object between angles chosen by the user.

28. The information browser of claim 26, wherein the information browser is operable to extrude portions of a two dimensional browser object to different extents as chosen by the user.

29. The information browser of claim 1, wherein the information browser is operable to display highlight child objects of parent objects by means of glows, lines, dashes, animations, or user defined images, such that instances of such lines, dashes, animations, and user defined images stretch from the parent object to the child objects indicating their dependence.
